(19) United States
(12) Patent Application Publication
(10) Pub. No.: US 2017/0019958 A1
(43) Pub. Date: Jan. 19, 2017

(54) METHOD FOR ILLUMINATING KNOBS OF A COOKING APPLIANCE

(71) Applicant: General Electric Company, Schenectady, NY (US)

(72) Inventors: Henry Nader Kobraei, Louisville, KY (US); Daniel Joseph Trice, Louisville, KY (US)

(21) Appl. No.: 14/799,902

(22) Filed: Jul. 15, 2015

(51) Int. Cl. H05B 6/12; H05B 6/06

(52) U.S. Cl. CPC H05B 6/1218; H05B 6/062

(57) ABSTRACT

A method for illuminating a knob of a cooking appliance is provided. The method includes positioning a cooking utensil on a cooking surface of the cooking appliance, rotating the knob in order to activate a heating element of the cooking appliance and sequentially activating a plurality of light emitting diodes beneath the knob.

### FIELD OF THE INVENTION

The subject matter of the present disclosure relates generally to control knobs on an appliance such as a cooking appliance.

### BACKGROUND OF THE INVENTION

Knobs are commonly used on a variety of commercial and residential appliances to control an operating condition of the appliance. Knobs are particularly common on cooking appliances, such as stoves or cooktops. Various shapes and sizes can be used depending upon e.g., the intended application, aesthetics and other factors.

For example, cooktops traditionally have at least one heating element positioned at a cooktop surface for use in heating or cooking an object, such as a cooking utensil, and its contents. The at least one heating element may heat a cooking utensil directly through induction heating, or may use another heat source such as electrically resistant coils or gas burners. Cooktops generally include a display for communicating to a user of the cooktops a status of the heating element. However, displays can be cosmetically unappealing and visually obtrusive.

Accordingly, a method for communicating a status of a cooking appliance to a user of the cooking appliance without a display would be useful.

### BRIEF DESCRIPTION OF THE INVENTION

The present disclosure provides a method for illuminating a knob of a cooking appliance. The method includes positioning a cooking utensil on a cooking surface of the cooking appliance, rotating the knob in order to activate a heating element of the cooking appliance and sequentially activating a plurality of light emitting diodes beneath the knob. Additional aspects and advantages of the invention will be set forth in part in the following description, or may be apparent from the description, or may be learned through practice of the invention.

In one exemplary embodiment, the present disclosure provides a method for illuminating a knob on a cooking appliance. The method includes positioning a cooking utensil on a cooking surface of the cooking appliance, rotating the knob in order to activate an induction heating element of the cooking appliance, and sequentially activating each light emitting diode (LED) of a plurality of light emitting diodes if the induction heating element does not heat the cooking utensil after the step of rotating. The plurality of light emitting diodes is distributed in a circular pattern below the knob.

In another exemplary embodiment, the present disclosure provides a method for illuminating a knob on a cooking appliance. The method includes positioning a cooking utensil on a cooking surface of the cooking appliance, rotating the knob in order to activate a heating element of the cooking appliance, and sequentially activating a plurality of light emitting diodes if a temperature of the cooking surface exceeds a predetermined temperature after the step of rotating. The plurality of light emitting diodes is positioned below the knob.

In an additional exemplary embodiment, the present disclosure provides a method for illuminating a knob on a cooking appliance. The method includes positioning a cooking utensil on a cooking surface of the cooking appliance, rotating the knob in order to activate an induction heating element of the cooking appliance, and sequentially adjusting an intensity of light emitted by each light emitting diode (LED) of a plurality of light emitting diodes if the induction heating element does not heat the cooking utensil after the step of rotating. The plurality of light emitting diodes is distributed in a circular pattern below the knob.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a cooking appliance of the present disclosure.

FIG. 2 provides a perspective view of a knob of the exemplary cooking appliance of FIG. 1.

FIG. 3 provides a top, plan view of the knob of the exemplary cooking appliance of FIG. 1.

FIG. 4 illustrates a method for illuminating a knob of a cooking appliance according to an exemplary embodiment of the present subject matter.

### DETAILED DESCRIPTION OF THE INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

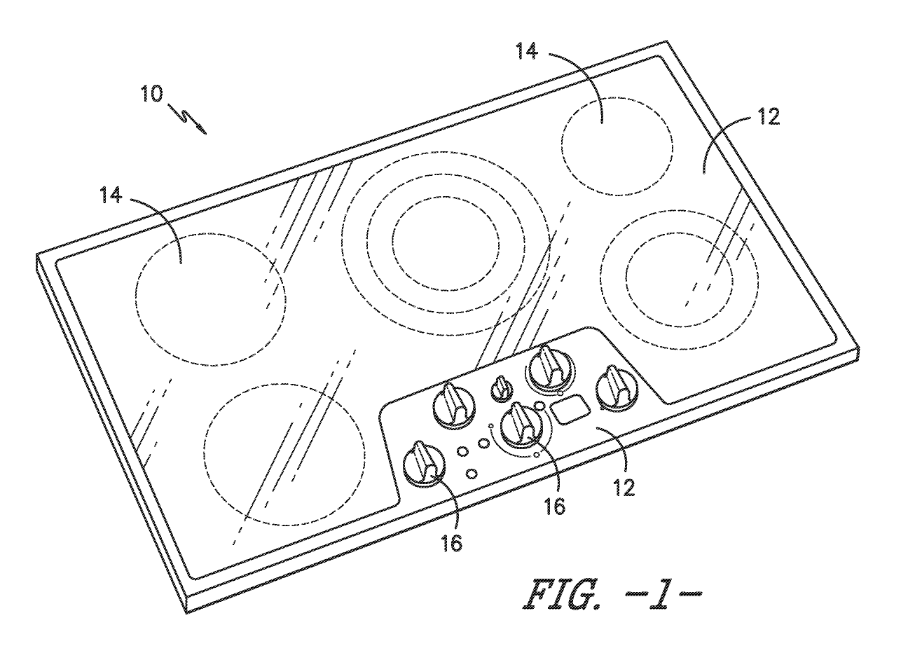

The present disclosure relates generally to a system for illuminating knobs on a cooking appliance. FIG. 1 illustrates an exemplary embodiment of a cooking appliance 10 of the present disclosure. Cooking appliance 10 may be, e.g., fitted integrally with a surface of a kitchen counter, or be a part of one or more oven appliances. Cooking appliance 10 may include a chassis (not shown).

Cooking appliance 10 also includes a cooktop surface 12 having one or more heating elements 14 for use in, e.g., heating or cooking. Cooktop surface 12, as used herein, refers to any surface of cooking appliance 10. For example, the present disclosure contemplates exemplary embodiments where the entirety of cooktop surface 12 is comprised of a single suitable material and other embodiments where cooktop surface 12 is comprised of one material proximate to heating elements 14 and another material proximate to knobs 16. In one exemplary embodiment, cooktop surface 12 is comprised of ceramic glass. In other embodiments, however, cooktop surface 12 may be comprised of another suitable material, such as a metallic material (e.g., steel) or other suitable non-metallic material. Heating elements 14 may be various sizes, as shown in FIG. 1, and may employ any suitable method for heating or cooking an object, such as a cooking utensil (not shown), and its contents. In one embodiment, for example, heating element 14 uses a heat transfer method, such as electric coils or gas burners, to heat the cooking utensil. In another embodiment, however, heating element 14 uses an induction heating method to heat the cooking utensil directly.

The amount of heat delivered by each heating element 14 on cooktop surface 12 is controlled by a corresponding control knob 16. Knob 16, as used herein, refers to any configuration of rotary dial, and not just one having a circular base, as shown in FIG. 1. For example, the present disclosure contemplates exemplary embodiments wherein knobs 16 have a rectangular base, an ovular base, or any other shape having one or more curved lines, straight lines, or both. As an example, knob 16 may be constructed in accordance with or include features of the knob described in U.S. Patent Publication No. 2014/0204557 of Cadima et al. entitled “ILLUMINATED KNOBS FOR AN APPLIANCE,” which is hereby incorporated by reference for all purposes. Thus, as discussed in greater detail below, light sources may be positioned at or adjacent a bottom portion 19 of knob 16 in order to illuminate knob 16 from below.

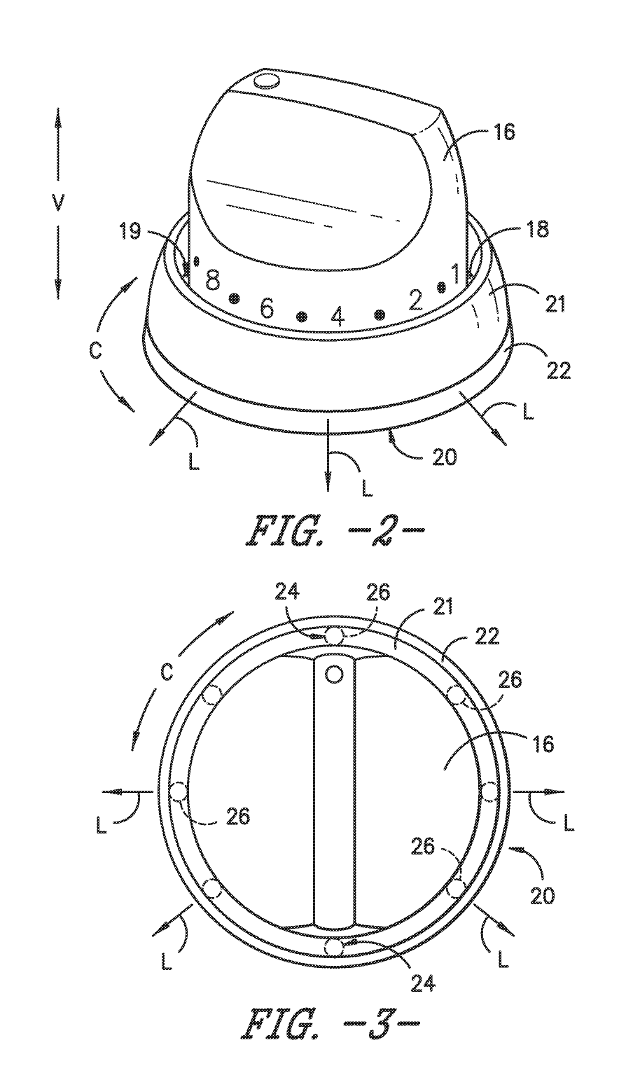

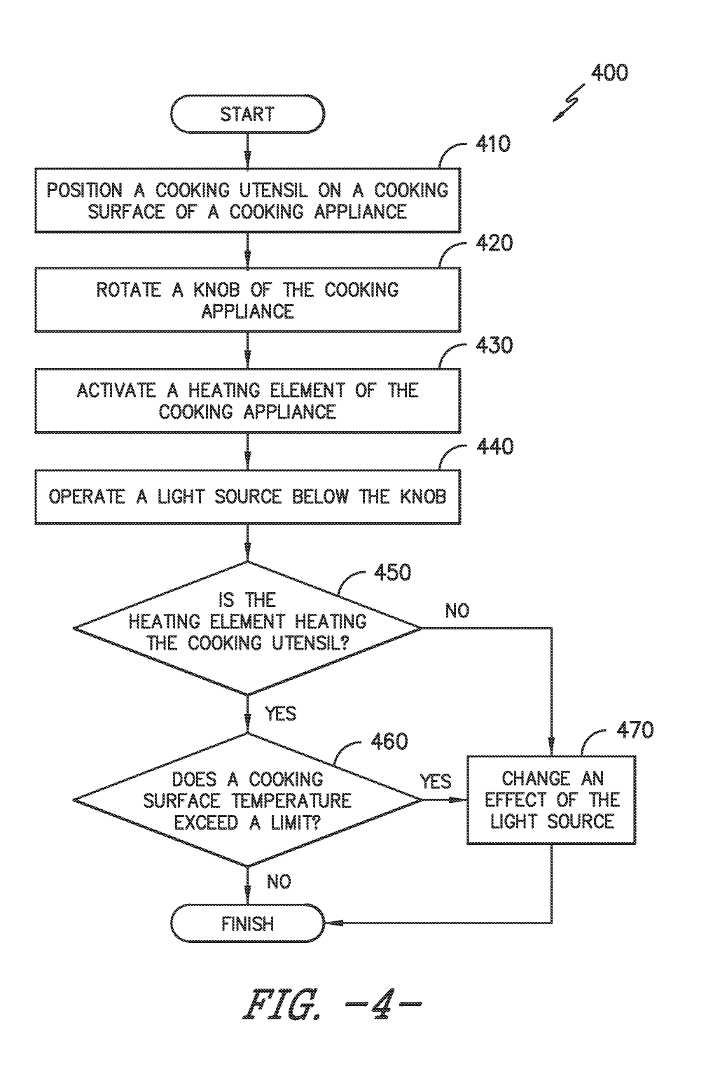

FIGS. 2 and 3 provide views of knob 16 and an illumination assembly 20 for illuminating knob 16 on cooking appliance 10. In one exemplary embodiment, illumination assembly 20 includes a light transmissive insert or skirt 22 positioned at or adjacent a bottom portion 19 of knob 16, e.g., on cooktop surface 12 below an opaque insert or skirt 21. Skirt 22 is comprised of a transparent material, a translucent material, or both. In one exemplary embodiment, skirt 22 may have a circular or annular shape, such as a flat disc shape. Additionally, skirt 22 may be fixed to cooktop surface 12 in any suitable manner, such as by using any suitable binding material.

In the exemplary embodiment of FIGS. 2 and 3, illumination assembly 20 also includes a light source 24 located proximate to skirt 22, e.g., and below cooktop surface 12. Light source 24 is positioned to direct light (shown with arrows L) through skirt 22 on cooktop surface 12. As discussed in greater detail below, light source 24 may be configured for illuminating based on one or more operating conditions of heating element 14, cooking appliance 10 (shown in FIG. 1) or both.

Light source 24 may be any suitable light source or combination of light sources. For example, light source 24 may include at least one light emitting diode (LED), configured for illuminating as a single color. As another example, light source 24 may include more than one LED and be capable of illuminating in different colors based on one or more operating conditions of heating element 14, cooking appliance 10 or both. As yet another example, light source 24 may be another electrical light source, such as one or more traditional light bulbs. As shown in FIG. 3, light source 24 may include a series or plurality of LEDs 26 distributed in a circular pattern at or adjacent a bottom portion 19 of knob 16. Thus, LEDs 26 may be spaced apart from each other or distributed along the circumferential direction C beneath knob 16.

Knob 16 may be positioned on or coupled to a stem of a heating element control such that rotating knob 16 a certain amount in a circumferential direction C rotates the stem the same amount in the circumferential direction C. Knob 16 may have a bottom surface 18 that is illuminated by light source 24, as shown in FIG. 3. For this embodiment, bottom surface 18 of knob 16 is elevated in vertical direction V from cooktop surface 12. However, in other embodiments, knob 16 may be positioned such that bottom surface 18 is not elevated relative to cooktop surface 12.

FIG. 4 illustrates a method 400 for illuminating a knob of a cooking appliance according to an exemplary embodiment of the present subject matter. Method 400 may be used to illuminate any suitable knob. For example, method 400 may be used with light source 24 to illuminate knob 16 on cooktop surface 12. Thus, method 400 is described in greater detail below in the context of cooking appliance 10. As discussed above, light source 24 may be operated based on one or more operating conditions of heating element 14, cooking appliance 10 (shown in FIG. 1) or both. Utilizing method 400, various operating conditions of cooking appliance 10 may be communicated to a user of cooking appliance 10 via light source 24, e.g., by changing a lighting effect provided by light source 24.

As may be seen in FIG. 4, method 400 includes placing a cooking utensil, such as a pan, pot, etc., on a cooking surface, such as cooktop surface 12, of cooking appliance 10 at step 810. As an example, a user of cooking appliance 10 may place the cooking utensil on the cooking surface of cooking appliance 10 over one of heating elements 14 at step 810. At step 820, one of knobs 16 may be rotated. As an example, the user of cooking appliance 10 may rotate one of knobs 16 associated with the respective heating element 14 which is positioned below the cooking utensil on the cooking surface of cooking appliance 10 at step 820. Thus, heating of the cooking utensil on the cooking surface of cooking appliance 10 may be initiated at step 830 in response to rotating knob 16 at step 820.

At step 840, light source 24 is operated. Operating light source 24 at step 840 may assist with alerting the user of cooking appliance 10 that the heating element 14 associated with knob 16 is activated or operational. Thus, when the user of cooking appliance 10 sees light L emitted from light source 24, the user may know that heating element 14 is activated or operational. As an example, light source 24 may be configured for emitting light constantly at step 840. In particular, light source 24 may be configured such that light source 24 emits red (or any other suitable color) light constantly at step 840 in order to communicate to the user of cooking appliance 10 that heating element 14 is activated or operational.

As discussed above, heating elements 14 may be induction heating elements. Thus, ferromagnetic cooking utensils may be required for heating elements 14 to heat cooking utensils on the cooking surface of cooking appliance 10 at step 830. In particular, an iron or steel cooking utensil may be required for heating elements 14 to suitably heat the cooking utensil when heating elements 14 are induction heating elements, e.g., such that magnetic waves from heating elements 14 engage the cooking utensil, as will be understood by those skilled in the art. Conversely, when non-ferromagnetic cooking utensils are positioned on the cooking surface of cooking appliance 10 and heating elements 14 are induction heating elements, heating elements 14 may be incapable of heating the cooking utensils. In such conditions, light source 24 may be configured for communicating to the user of cooking appliance 10 that heating element 14 is not heating the cooking utensil positioned on the cooking surface of cooking appliance 10.

At step 450, it may be determined whether heating element 14 is heating the cooking utensil positioned on the cooking surface of cooking appliance 10 and/or whether the cooking utensil positioned on the cooking surface of cooking appliance 10 is a ferromagnetic cooking utensil. Any suitable method or mechanism may be used to determine the composition and/or presence of the cooking utensil positioned on the cooking surface at step 450. For example, mechanical switching, phase detection, optical sensing, harmonic distortion sensing, etc. may be used to determine the composition and/or presence of the cooking utensil positioned on the cooking surface at step 450, as will be understood by those skilled in the art. If heating element 14 is heating the cooking utensil positioned on the cooking surface of cooking appliance 10 and/or if the cooking utensil positioned on the cooking surface of cooking appliance 10 is a ferromagnetic cooking utensil at step 450, method 400 proceeds to step 460. Conversely, method 400 proceeds to step 470 if heating element 14 is not heating the cooking utensil positioned on the cooking surface of cooking appliance 10 and/or if the cooking utensil positioned on the cooking surface of cooking appliance 10 is not a ferromagnetic cooking utensil at step 450.

At step 470, a lighting effect of light source 24 is adjusted or changed. As used herein the term “lighting effect” corresponds to at least one of an intensity of light L emitted by light source 24, a color of light L emitted by light source 24, an on/off status of light source 24 and a frequency and/or selection of activated LEDs 26. Thus, at step 470, the light L emitted by light source 24 may be adjusted or changed, e.g., to communicate to the user of cooking appliance 10 that heating element 14 is not heating the cooking utensil positioned on the cooking surface of cooking appliance 10 and/or that the cooking utensil positioned on the cooking surface of cooking appliance 10 is not a ferromagnetic cooking utensil. As an example, light source 24 may be adjusted such that LEDs 26 are sequentially activated rather than constantly operated at step 370. In particular, LEDs 26 may be sequentially activated in a plurality of consecutive activation stages, and only one LED of LEDs 26 may emit light L during each activation stage of the plurality of consecutive activation stages. Further, each LED of LEDs 26 may be activated after a respective adjacent LED of LEDs, e.g., along the circumferential direction C, is deactivated. In such a manner, LEDs 26 may be operated in a chasing pattern at step 370, e.g., to communicate to the user of cooking appliance 10 that heating element 14 is not heating the cooking utensil positioned on the cooking surface of cooking appliance 10 and/or that the cooking utensil positioned on the cooking surface of cooking appliance 10 is not a ferromagnetic cooking utensil. In alternative exemplary embodiments, the intensity of light L may be adjusted to operate LEDs 26 such that LEDs 26 operate in the chasing pattern. In the chasing pattern, light L emitted by LEDs 26 may appear to move around knob 16, e.g., along the circumferential direction C. The light L emitted by light source 24 at step 470 may be blue or any other suitable color at step 470.

At step 460, a temperature of the cooking surface of cooking appliance 10 is measured and compared to a predetermined temperature. Any suitable method or mechanism may be used to determine the temperature of the cooking surface of cooking appliance 10 at step 470, such as a thermistor, thermocouple, etc. The predetermined temperature may also be any suitable temperature, e.g., four hundred degrees Fahrenheit. The predetermined temperature may be selected to avoid or limit combustion of materials on cooking surface of cooking appliance 10. As another example, the predetermined temperature may be selected such that the predetermined temperature corresponds to a “hot to touch temperature,” e.g., one hundred and twenty degrees Fahrenheit.

If the temperature of the cooking surface of cooking appliance 10 exceeds (or meets) the predetermined temperature, method 400 proceeds to step 470. Thus, the lighting effect of light source 24 is adjusted or changed at step 470, e.g., to communicate to the user of cooking appliance 10 that the temperature of the cooking surface of cooking appliance 10 exceeds (or meets) the predetermined temperature. As an example, light source 24 may be adjusted such that light L emitted by light source 24 changes color at step 470, e.g., from red to blue. As another example, light source 24 may be adjusted such that LEDs 26 are sequentially activated rather than constantly operated at step 370. In particular, LEDs 26 may constantly emit light during alternating activation stages of the plurality of consecutive activation stages at step 470. In such a manner, LEDs 26 may operate in a pulsing or flashing pattern at step 470, e.g., to communicate to the user of cooking appliance 10 that the temperature of the cooking surface of cooking appliance 10 exceeds (or meets) the predetermined temperature.

Method 400 may assist with operating light source 24 such that light source 24 backlights knob 16 and/or illuminates skirt 22 below knob 16 to provide various lighting effects, including but not limited to luminous intensity, on/off times, color and adjacent LED patterns. In such a manner, light source 24 may create lighting effects that communicates a status of cooking appliance 10 to a user of cooking appliance 10, including but not limited to cooktop surface temperature, cooktop on/off status, cooktop pan detection, cooktop boil over, cooktop lockout and cooktop glass over temp. Thus, method 400 may communicate the status of cooking appliance 10 in an elegant and/or appealing manner relative to conventional illuminated text, such as “HOT COOKTOP.” The changing lighting effect provided by method 400 may also increase user satisfaction, publicity and/or interest in an associated cooking appliance.

Certain cooking appliances include multiple heating elements, such as four heating elements and one warming zone, with a knob to control each. In such arrangement, the cooking appliance may include a bridge knob that operates a set of heating elements, e.g., two heating elements positioned on a left side of the cooking appliance. The bridge knob may control the set of heating elements so that the set of heating elements operates like a bridge, e.g., for use with a griddle. When the bridge knob is rotated and the bridge mode is activated, method 700 may include resetting a power level of the set of heating elements to zero, e.g., even if other the other knobs operatively coupled to the set of heating elements are rotated. In addition, method 700 may include flashing light sources behind the other knobs operatively coupled to the set of heating elements in order to communicate to the user to reset the other knobs when the bridge knob is rotated and the bridge mode is activated. The lighting effect may be adjusted in any other suitable manner to communicate to the user that the other knobs need to be reset when the bridge knob is rotated and the bridge mode is activated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for illuminating a knob on a cooking appliance, comprising:
positioning a cooking utensil on a cooking surface of the cooking appliance;
rotating the knob in order to activate an induction heating element of the cooking appliance; and
sequentially activating each light emitting diode (LED) of a plurality of light emitting diodes if the induction heating element does not heat the cooking utensil after said step of rotating, the plurality of light emitting diodes distributed in a circular pattern below the knob.

2. The method of claim 1, wherein said step of sequentially activating comprises a plurality of consecutive activation stages, only one LED of the plurality of light emitting diodes emitting light during each activation stage of the plurality of consecutive activation stages.

3. The method of claim 1, wherein each LED of the plurality of light emitting diodes is activated after a respective adjacent LED of the plurality of light emitting diodes is deactivated during said step of sequentially activating.

4. The method of claim 1, wherein the plurality of light emitting diodes operates in a chasing pattern during said step of sequentially activating.

5. The method of claim 1, further comprising constantly operating each LED of the plurality of light emitting diodes at said step of rotating and before said step of sequentially activating.

6. The method of claim 5, wherein light emitted by the plurality of light emitting diodes is a first color at said step of constantly operating and light emitted by the plurality of light emitting diodes is a second color at said step of sequentially activating, the first color being different than the second color.

7. The method of claim 6, wherein the first color is red and second color is blue.

8. A method for illuminating a knob on a cooking appliance, comprising:
positioning a cooking utensil on a cooking surface of the cooking appliance;
rotating the knob in order to activate a heating element of the cooking appliance; and
sequentially activating a plurality of light emitting diodes if a temperature of the cooking surface exceeds a predetermined temperature after said step of rotating, the plurality of light emitting diodes positioned below the knob.

9. The method of claim 8, wherein said step of sequentially activating comprises a plurality of consecutive activation stages, each LED of the plurality of light emitting diodes emitting light during alternating activation stages of the plurality of consecutive activation stages.

10. The method of claim 8, wherein the plurality of light emitting diodes operates in a flashing pattern during said step of sequentially activating.

11. The method of claim 8, further comprising constantly operating each LED of the plurality of light emitting diodes at said step of rotating and before said step of sequentially activating.

12. The method of claim 11, wherein light emitted by the plurality of light emitting diodes is a first color at said step of constantly operating and light emitted by the plurality of light emitting diodes is a second color at said step of sequentially activating, the first color being different than the second color.

13. The method of claim 12, wherein the first color is blue and second color is red.

14. A method for illuminating a knob on a cooking appliance, comprising:
positioning a cooking utensil on a cooking surface of the cooking appliance;
rotating the knob in order to activate an induction heating element of the cooking appliance; and
sequentially adjusting an intensity of light emitted by each light emitting diode (LED) of a plurality of light emitting diodes if the induction heating element does not heat the cooking utensil after said step of rotating, the plurality of light emitting diodes distributed in a circular pattern below the knob.

15. The method of claim 14, wherein the intensity of light emitted by each LED of the plurality of light emitting diodes is adjusted after a respective adjacent LED of the plurality of light emitting diodes is adjusted during said step of sequentially adjusting.

16. The method of claim 14, wherein the plurality of light emitting diodes operates in a chasing pattern during said step of sequentially adjusting.

17. The method of claim 14, further comprising constantly operating each LED of the plurality of light emitting diodes at said step of rotating and before said step of sequentially adjusting.

18. The method of claim 17, wherein light emitted by the plurality of light emitting diodes is a first color at said step of constantly operating and light emitted by the plurality of light emitting diodes is a second color at said step of sequentially adjusting, the first color being different than the second color.

19. The method of claim 18, wherein the first color is red and second color is blue.
